(19) United States
(12) Patent Application Publication
(10) Pub. No.: US 2006/0209127 A1
(43) Pub. Date: Sep. 21, 2006

(54) Droplet ejection head, method of producing the same, and droplet ejection apparatus

(75) Inventor: Hiroshi Inoue, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/296,171

(22) Filed: Dec. 7, 2005

(30) Foreign Application Priority Data
Mar. 18, 2005 (JP) 2005-080564

(51) Int. Cl. B41J 2/16

(52) U.S. Cl. 347/47

(57) ABSTRACT

The invention provides a droplet ejection head having a nozzle plate provided with a nozzle for ejecting droplets and a water-repellent film provided on the nozzle plate. The water-repellent film contains an inorganic ultraviolet absorbing agent. A method of producing the droplet ejection head and a droplet ejection apparatus provided with this droplet ejection head are also disclosed.

### CROSS-REFERENCE TO RELATED APPLICATION

This application claims priority under 35 USC 119 from Japanese Patent Application No. 2005-080564, the disclosure of which is incorporated by reference herein.

### BACKGROUND OF THE INVENTION

1. Field of the Invention

The invention relates to a droplet ejection head that performs recording of images by ejecting droplets, exemplified, for example, by an ink jet recording method, as well as to a method of manufacturing the droplet ejection head and a droplet ejection apparatus provided with the droplet ejection head.

2. Description of the Related Art

Conventionally, an ink jet recording apparatus has been known among droplet ejection apparatus that perform printing on a recording medium such as a paper sheet by ejecting droplets from plural nozzles. This ink jet recording apparatus is widely commercially available because of having various advantages such as being small, inexpensive, and quiet. In particular, recording apparatus of piezoelectric ink jet type that eject ink droplets by changing the pressure within a pressure chamber with the use of a piezoelectric element or recording apparatus of thermal ink jet type that eject ink droplets by expanding the ink with the use of the action of thermal energy have numerous advantages such as providing high-speed printing and high resolution.

In such recording apparatus of ink jet type, a nozzle surface is coated with a water-repellent film so as to prevent ink droplets from adhering to the periphery of the nozzle when the ink droplets are ejected from plural nozzles. However, when the paper sheet moves up due to jamming or the like, this water-repellent film is subjected to abrasion damage due to paper abrasion, whereby ink ejecting performance is deteriorated due to, for example, tilting of the ink ejection direction or variation in the ink droplet diameter and speed.

As a countermeasure to this, an ink jet recording head, for example, has been proposed in which a circular step is provided around the nozzle formed in the nozzle plate. In this ink jet recording head, a metal plate having a circular aperture corresponding to the nozzle is bonded to a nozzle plate having nozzles formed therein, whereby a circular step is formed around the nozzle so as to prevent the paper sheet from contacting the water-repellent film around the nozzle (see, for example, Japanese Patent No. 3108771).

In such a recording head provided with a step, when the water-repellent film is applied by the spin coating method, in the case of the above-mentioned recording head provided with the step, the application onto the bottom part of the step is insufficient. In contrast, when the water-repellent film is applied by the spray coating method, although the water-repellent film can be sufficiently applied onto the bottom part of the step, this spray coating is not suitable for application of a thin film, and thus the water-repellent film becomes thick, thereby causing inconvenience in forming nozzles. Typically, for nozzle forming, a laser having a wavelength in the ultraviolet region (for example, an excimer laser) is used. However, a fluorine type resin that does not absorb a wavelength in the ultraviolet region is often used for the water-repellent film. Although this does not cause a problem in the case of a thin film, this causes an inconvenience in forming nozzles in the case of a thick film because the thick film itself cannot not be processed.

In the meantime, for the purpose of forming good nozzles, it has been proposed to blend an ultraviolet absorbing agent into a water-repellent film (see, for example, Japanese Patent No. 3108771 and Japanese Patent Application Laid-Open (JP-A) Nos. 6-328698, 7-304177, and 11-277749). However, these ultraviolet absorbing agents are organic materials and often cease to function as an ultraviolet absorbing agent when a thermal treatment is carried out before the nozzle forming, and thus an improvement is desired.

### SUMMARY OF THE INVENTION

The invention has been made in view of the above circumstances, and provides a droplet ejection head, a method of producing the same, and a droplet ejection apparatus provided with this droplet ejection head.

A first aspect of the invention provides a droplet ejection head including a nozzle plate provided with a nozzle for ejecting droplets and a water-repellent film provided on the nozzle plate, wherein the water-repellent film contains an inorganic ultraviolet absorbing agent.

A second aspect of the invention provides a method of producing a droplet ejection head including: forming a water-repellent film containing an inorganic ultraviolet absorbing agent on a nozzle plate before forming a nozzle for ejecting droplets; and forming the nozzle in the nozzle plate by applying to the nozzle plate a laser beam having a wavelength in the ultraviolet region from a side of a surface where the water-repellent film is formed.

A third aspect of the invention provides a droplet ejection apparatus provided with the droplet ejection head of the first aspect.

### BRIEF DESCRIPTION OF THE DRAWINGS

FIG. 1 is a schematic constructional view showing an ink jet recording apparatus according to an embodiment of the invention;

FIG. 2 is a schematic view showing a recording head arrangement of an ink jet recording unit according to an embodiment of the invention;

FIG. 3 is a view showing a print area with an ink jet recording unit of an embodiment;

FIG. 4 is a schematic cross-sectional view showing a construction of an ink jet recording head according to an embodiment of the invention; and

FIGS. 5A to 5F are process views showing a process of producing an ink jet recording head according to an embodiment of the invention.

### DETAILED DESCRIPTION OF THE INVENTION

A droplet ejection head of the invention includes a nozzle plate provided with a nozzle for ejecting droplets and a water-repellent film provided on the nozzle plate, characterized in that the water-repellent film contains an inorganic ultraviolet absorbing agent.

In the droplet ejection head of the invention, the water-repellent film contains an inorganic ultraviolet absorbing agent having a higher melting point than organic ultraviolet absorbing agents. Therefore, even if a thermal treatment is carried out after forming the water-repellent film in producing the head, the inorganic ultraviolet absorbing agent can maintain the ultraviolet absorption capability without being decomposed. For this reason, good nozzles can always be formed irrespective of the production steps, such as performing a thermal treatment or forming the water-repellent film with a thick film at the time of producing the head.

In the droplet ejection head of the invention, it is suitable that the inorganic ultraviolet absorbing agent is selected from the group consisting of titanium oxide, cerium oxide, zinc oxide, tin oxide, and iron oxide. These inorganic ultraviolet absorbing agents can be suitably used because of having a sufficient ultraviolet absorption capability and a high melting point.

In the droplet ejection head of the invention, it is suitable that the water-repellent film is formed by spray coating. This spray coating can provide a good application even when a surface state such as unevenness is present in the object of application, so that a water-repellent film can be formed to have a uniform thickness even if the film is a thick film.

On the other hand, a method of producing a droplet ejection head of the invention includes:

forming a water-repellent film containing an inorganic ultraviolet absorbing agent on a nozzle plate before forming a nozzle for ejecting droplets; and

forming the nozzle in the nozzle plate by applying to the nozzle plate a laser beam having a wavelength in the ultraviolet region from a side of a surface where the water-repellent film is formed.

In the method of producing a droplet ejection head of the invention, the water-repellent film also contains an inorganic ultraviolet absorbing agent having a higher melting point than organic ultraviolet absorbing agents. Therefore, even if a thermal treatment is carried out after forming the water-repellent film in producing a head, the inorganic ultraviolet absorbing agent can maintain the ultraviolet absorption capability without being decomposed. For this reason, good nozzles can always be formed irrespective of the production steps, such as performing a thermal treatment or forming the water-repellent film with a thick film at the time of producing the head.

The method of producing a droplet ejection head of the invention can further include joining a flow passageway plate, which is provided with at least a part of a flow passageway for droplets that is in communication with the nozzle, onto a surface that is opposite to the surface of the nozzle plate where the water-repellent film is formed, after forming the water-repellent film. Even if a flow passageway joining step that is accompanied by a thermal treatment is carried out before the nozzle forming step, the inorganic ultraviolet absorbing agent can maintain the ultraviolet absorbing capability at the time of forming the nozzle, so that good nozzles can be formed.

In the method of producing a droplet ejection head of the invention, it is suitable that the inorganic ultraviolet absorbing agent is selected from the group consisting of titanium oxide, cerium oxide, zinc oxide, tin oxide, and iron oxide. These inorganic ultraviolet absorbing agents can be suitably used because of having a sufficient ultraviolet absorption capability and a high melting point.

In the method of producing a droplet ejection head of the invention, it is suitable that the step of forming the water-repellent film is carried out by spray coating. This spray coating can provide a good application even when a surface state such as unevenness is present in the object of application, so that a water-repellent film can be formed to have a uniform thickness even if the film is a thick film.

The droplet ejection apparatus of the invention is characterized by being provided with the above-described droplet ejection head of the invention.

Since the droplet ejection apparatus of the invention includes the above-described droplet ejection head of the invention, droplets can be ejected well.

Hereafter, the invention will be described with reference to the attached drawings. Here, members having substantially the same function may be denoted with the same symbols all throughout the drawings, and duplicated description thereof may be omitted in some cases.

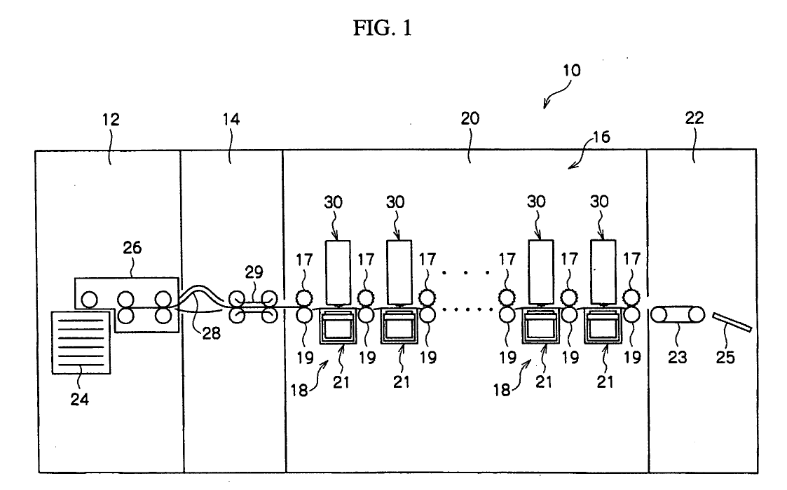

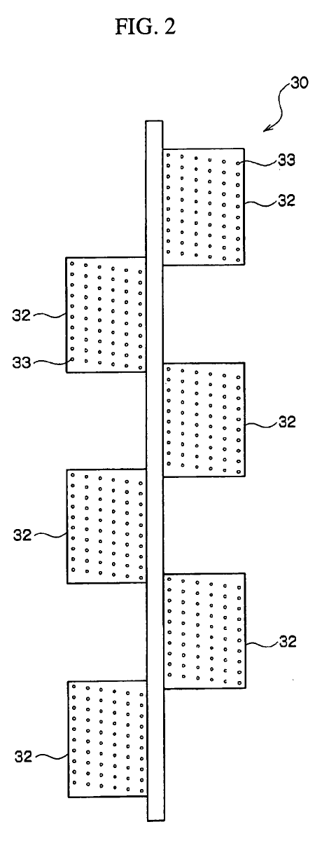

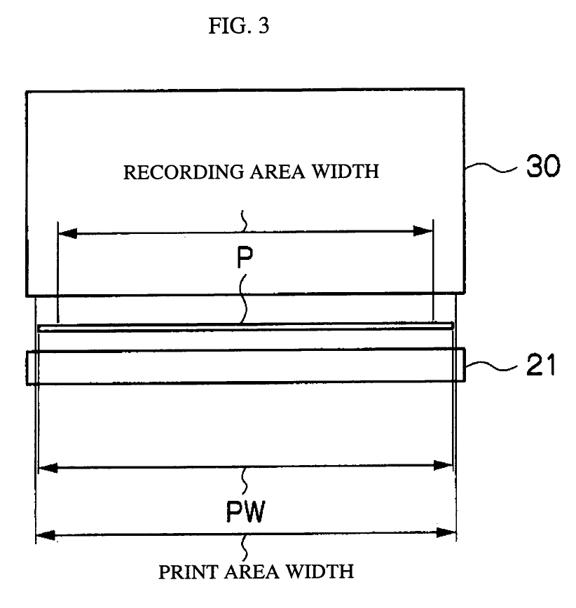

FIG. 1 is a schematic constructional view showing an ink jet recording apparatus according to an embodiment of the invention. FIG. 2 is a schematic view showing a recording head arrangement of an ink jet recording unit according to the embodiment of the invention. FIG. 3 is a view showing a print area with the ink jet recording unit of the embodiment.

Referring to FIG. 1, an ink jet recording apparatus 10 (droplet ejection apparatus) according to this embodiment is basically constructed with a paper sheet supplying section 12 for sending paper sheets out; a registration adjustment section 14 for controlling the posture of the paper sheets; a recording section 20 including a recording head section 16 for forming images on a recording medium P by ejecting ink droplets (liquid droplets), and a maintenance section 18 for performing maintenance of the recording head 16; and a discharging section 22 for discharging the paper sheets on which the images have been formed in the recording section 20.

The paper sheet supplying section 12 is constructed with a stocker 24 in which the paper sheets are stacked and stocked, and a transportation apparatus 26 for feeding the paper sheets one by one from the stocker 24 and transporting the paper sheets to the registration adjustment section 14.

The registration adjustment section 14 includes a loop forming section 28 and a guide member 29 for controlling the posture of the paper sheets. When the paper sheets pass by this part, the skew of the paper sheets is corrected with the use of the elasticity of the paper sheets, and the paper sheets proceed into the recording section 20 with control of the transportation timing.

In the discharging section 22, the paper sheets on which the images have been formed by the recording section 20 are stored into a tray 25 via a paper discharging belt 23.

Between the recording head 16 and the maintenance section 18, a paper sheet transportation passageway is constructed for transporting the recording medium P. The recording medium P is continuously (without stopping) transported while the recording medium P is being sandwiched between a star wheel 17 and a transportation roll 19. Ink droplets are ejected from the recording head section 16 to this paper sheet, whereby an image is formed on the recording medium P.

The maintenance section 18 is constructed with a maintenance apparatus 21 that is disposed opposite to the ink jet recording unit 30 (recording head 32), and can perform processes such as capping, wiping, dummy jetting, and vacuum on the ink jet recording unit 30 (recording head 32).

Referring to FIG. 2, each of the ink jet recording units 30 includes plural ink jet recording heads 32 that are arranged in a direction perpendicular to the paper sheet transportation direction. Plural nozzles 33 are formed in a matrix form in the ink jet recording head 32. By ejecting ink droplets from the nozzles 33 to the recording medium P that is transported continuously in the paper sheet transportation passageway, an image is formed on the recording medium P. Here, at least four ink jet recording units 30 are provided, for example, in correspondence with each color of yellow, magenta, cyan, and black for recording a so-called full-color image.

Referring to FIG. 3, the print area width by the nozzles 33 of each ink jet recording unit 30 is set to be longer than the maximum paper sheet width PW of the recording medium P on which an image is assumed to be recorded by this ink jet recording apparatus 10, whereby an image can be formed over the total width of the recording medium P without moving the ink jet recording unit 30 in a paper sheet width direction (i.e. a so-called full width array (FWA)). Here, the print area is basically the maximum of the recording area obtained by subtracting a margin, where printing is not carried out, from the two ends of the paper sheet. However, the print area is generally set to be larger than the maximum paper sheet width PW serving as an object of printing. This is because there may be a case where the paper sheet is transported while being tilted (skewed) at a certain angle to the transportation direction, and that there is a high demand for printing without the brims.

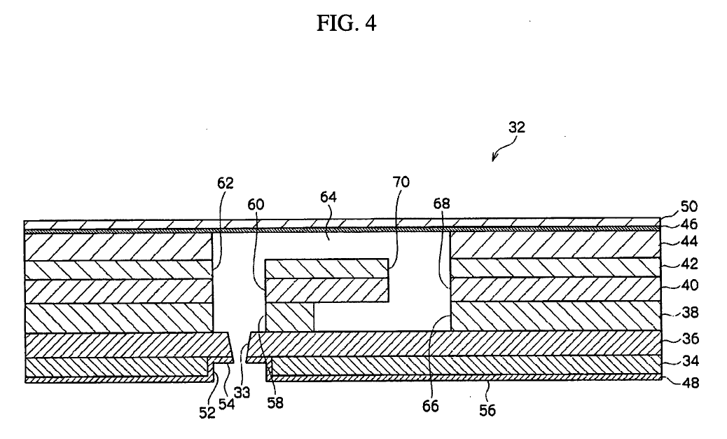

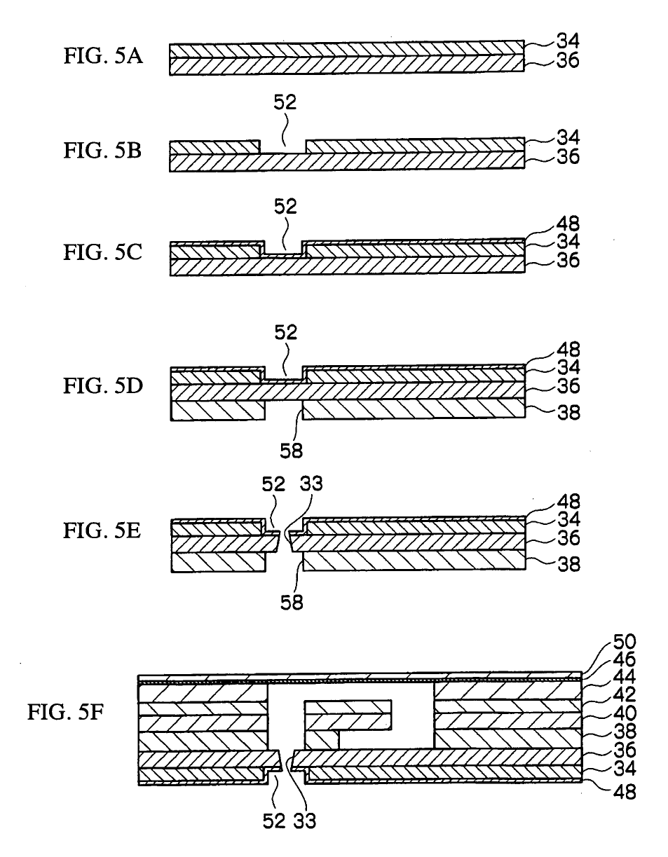

Next, in the ink jet recording apparatus 10 having a construction such as described above, the ink jet recording head 32 will be described in detail. FIG. 4 is a schematic cross-sectional view showing a construction of the ink jet recording head according to the embodiment of the invention. FIGS. 5A to 5F are process views showing a process of producing the ink jet recording head according to the embodiment of the invention.

Referring to FIG. 4, the ink jet recording head 32 is produced by laminating a protection plate 34, a nozzle plate 36, a pool plate 38, communication hole plates 40, 42, a pressure chamber plate 44, and a vibration plate 46 in position and bonding them by thermal fusion or with an adhesive. A water-repellent film 48 is formed on a surface of the protection plate 34 on the nozzle plate 36.

A nozzle 33 for ejecting ink is formed in the nozzle plate 36. A step hole 52 is formed around the nozzle 33 in the protection plate 34 joined to the nozzle plate 36. By means of this step hole 52, the nozzle surface 54 around the nozzle 33 is retreated in a concave manner from the plate surface 56 of the protection plate 34 (the surface of the protection plate 34 to which the water-repellent film 48 is applied). This prevents the recording medium P moving up at the time of printing from being brought into contact with the nozzle surface 56, so that the water-repellent film 48 around the nozzle 33 is not damaged. This water-repellent film 48 prevents adhesion of the ink to the surroundings of the nozzle 33 and, owing to this water-repellent film 48, the ink droplets ejected from the nozzle 33 are ejected always in a direction perpendicular to the plate surface 56.

In addition, referring to FIG. 4, in the pool plate 38, a communication hole 58 is formed in communication with the nozzle 33. Also, communication holes 60, 62 are formed in the communication hole plates 40, 42, respectively. The nozzle 33, the communication hole 58, and the communication holes 60, 62 are in communication in a state that the nozzle plate 36 and the communication hole plates 40, 42 are laminated, and are connected to a pressure chamber 64 formed in the pressure chamber plate 44.

On the other hand, an ink pool 66 is formed in the pool plate 38 so as to store the ink supplied from an ink supplying hole (not shown). Also, supplying holes 68, 70 are formed in the communication hole plates 40, 42, respectively, so as to be in communication with the ink pool 66. The ink pool 66, the supplying holes 68, 70, and the pressure chamber 64 are in communication in a state in which the pool plate 38, the communication hole plates 40, 42, and the pressure chamber plate 44 are laminated. On the vibration plate 46 (on the surface that is opposite to the surface joined to the pressure chamber plate 44), a single-plate type piezoelectric element 50 serving as pressure generating means is mounted above the pressure chamber 64, and a driving voltage is applied thereto from a flexible wiring substrate (not shown).

In the ink jet recording head 32 such as described above, a flow passageway for ink is formed that is continuous from the ink pool 66 to the supplying holes 68, 70, the pressure chamber 64, the communication holes 60, 62, the communication hole 58, and the nozzle 33, whereby the ink supplied from an ink supplying hole (not shown) and stored in the ink pool 66 is introduced into and fills the pressure chamber 64 via the supplying holes 68, 70. When a driving voltage is applied to the piezoelectric element 50, the vibration plate 46 is deformed by deflection together with the piezoelectric element 50, so as to expand or compress the pressure chamber 64. This generates a volume change in the pressure chamber 64, thereby generating a pressure wave in the pressure chamber 64. By action of this pressure wave, the ink is moved, whereby the ink droplets are ejected from the nozzle 33 to the outside.

Next, a method of producing the ink jet recording head 32 will be described.

First, referring to FIG. 5A, a plate-shaped nozzle plate 36 before forming the nozzle 33 and a plate-shaped protection plate 34 before forming the step hole 52 are joined by thermal fusion. By joining the two sheets of the nozzle plate 36 and the protection plate 34 by thermal fusion without the use of an adhesive, there is no need to perform position adjustment of the two at the time of joining, so that the two can be joined efficiently. The nozzle plate 36 is made of a synthetic resin which has an excellent mechanical strength, chemical resistance, and capability of being formed into a thin film. In this embodiment, the nozzle plate 36 is made of polyimide. Use of polyimide gives an advantage in that the nozzle plate 36 can be processed more easily than a conventional SUS, and can restrain cross-talking by a damper effect when ejection energy is given to the ink. The protection plate 34 is made of a metal plate, a resin film, a liquid crystal film, a resin plate, or the like. In this embodiment, the protection plate 34 is made of an SUS.

Subsequently, referring to FIG. 5B, a step hole 52 is formed in the plate-shaped protection plate 34. In forming the step hole 52, first, a resist is formed and, after this resist is patterned through a mask, unnecessary portion of the resist is removed to form a hole part corresponding to the position of the step hole 52. Then, by wet etching, a pattern of the step hole 52 is formed in the protection plate 34, followed by removing the resist. In this step hole 52, the depth of this step hole 52 is set to be, for example, from 5 μm to 20 μm.

Subsequently, referring to FIG. 5C, a water-repellent film 48 is formed by spray coating on the surface of the protection plate 34, i.e. on the ejection-side surface of the ink jet recording head 32 (See FIG. 1). By this spray coating, a water-repellent film 48 having a uniform film thickness can be formed not only on the surface of the protection plate 34 on the nozzle plate 36 but also within the step hole 52 (including the bottom part). The thickness of the water-repellent film 48 is set to be, for example, from 1 to 10 μm. In this embodiment, the thickness is set to be 2 μm.

Here, the constituent material of the water-repellent film 48 may be, for example, a fluorine-series resin such as tetrafluoroethylene-hexafluoropropylene copolymer resin (FEP), polytetrafluoroethylene resin (PTFE), tetrafluoroethylene-perfluoroalkoxyethylene copolymer resin (PFA), polyvinylidene fluoride resin, or polyvinyl fluoride resin. In particular, polytetrafluoroethylene resin (PTFE), tetrafluoroethylene-perfluoroalkoxyethylene copolymer resin (PFA) and tetrafluoroethylene-hexafluoropropylene copolymer resin (FEP) are suitable. In this embodiment, polytetrafluoroethylene resin (PTFE) is used.

In addition, the water-repellent film 48 contains an inorganic ultraviolet absorbing agent. Examples of the inorganic ultraviolet absorbing agent include titanium oxide (having a melting point of 1640° C.), cerium oxide (having a melting point of 1950° C.), zinc oxide (having a melting point of 1975° C.), tin oxide (having a melting point of 1080° C.), and iron oxide (having a melting point of 1360° C.). Among these, especially preferable ones are titanium oxide, cerium oxide, and zinc oxide. The content of these inorganic ultraviolet absorbing agents is, for example, 5 to 30 wt %, preferably 10 to 20 wt %, relative to the resin constituting the water-repellent film 48. In this embodiment, the content of titanium oxide relative to the resin is 10 wt %.

Subsequently, referring to FIG. 5D, the pool plate 38 is joined to the back surface of the nozzle plate 36 by thermal fusion. In the thermal fusion, an adhesive is not used at the time of joining. Typically, for this thermal fusion, a thermal treatment of 300 to 360° C. is carried out. In this embodiment, a thermal treatment of 330° C. is carried out for thermal fusion. Here, in this embodiment, a mode of joining by thermal fusion has been described; however, the joining may be carried out with the use of an adhesive. For joining in this case, a thermal treatment of, for example, 200° C. is carried out.

Subsequently, referring to FIG. 5E, a nozzle 33 is formed in the nozzle plate 36 by cutting with an excimer laser (not shown) from the rear of the pool plate 38 (i.e. from the water-repellent film 48 forming surface side). This nozzle 33 is formed to have an aperture diameter smaller than the hole diameter of the step hole 52. In this embodiment, the nozzle 33 is formed to have an aperture diameter of about 25 μm, and the step hole 52 is formed to have a diameter of 100 μm to 400 μm. Here, a plurality of these nozzles 33 and step holes 52 such as described above are formed in a predetermined pattern.

Here, in this embodiment, an excimer laser is used in forming nozzles; however, there is no particular limitation as long as a laser having a wavelength in the ultraviolet region is used. For example, a YAG triple harmonics wave, a YAG quadruple harmonics wave, or the like can be used as well. Here, in view of the processability, the excimer laser is the most suitable one.

In this manner, the first laminated plate is prepared. Meanwhile, referring to FIG. 5F, a second laminated plate is prepared in a separate step by joining communication hole plates 40, 42 and a pressure chamber plate 44 beforehand and further joining a vibration plate 46 to cover an opening of the pressure chamber plate 44. The first laminated plate and the second laminated plate are joined so that the communication plate 40 and the pool plate 38 thereof will face each other.

In this manner, an ink jet recording head 32 is prepared.

As describe above, in this embodiment, an inorganic ultraviolet absorbing agent is blended into the water-repellent film 48 in the ink jet recording head 32. Since this inorganic ultraviolet absorbing agent has a higher melting point than organic ones, the inorganic ultraviolet absorbing agent can maintain its ultraviolet absorption capability without being decomposed even if a thermal treatment using a high temperature is applied in joining the nozzle plate 36 and the pool plate 38 after forming the water-repellent film 48. For this reason, even with a nozzle plate 36 in which a thick water-repellent film 48 is formed by spray coating, good nozzles can be formed with the excimer laser. In this manner, in the recording head 32 according to this embodiment, good nozzles can always be formed irrespective of the production steps.

Then, an ink jet recording apparatus 10 provided with the recording head 32 such as described above has a good ink ejection property.

Here, in this embodiment, an example of FWA in accordance with the paper width has been described. However, the ink jet recording head of the invention is not limited to this, and can be applied also to an apparatus of partial width array (PWA) having a main scanning mechanism and a sub scanning mechanism.

Also, in this embodiment, images (including characters) are recorded on a recording medium P. However, the droplet ejection head and the droplet ejection apparatus of the invention are not limited to this alone. Namely, the recording medium is not limited to paper, and the liquid to be ejected is not limited to ink, either. For example, the invention can be applied generally to droplet ejection heads and droplet ejection apparatus that are industrially used for purposes such as preparing a color filter for a display device by ejection of ink onto a polymer film or glass, forming bumps for mounting electrical parts by ejection of solder in a molten state onto a substrate, or the like.

### EXAMPLES

Hereafter, in the above-described embodiment, evaluation is made by carrying out Examples 1 to 5 in which nozzles are formed by allowing an inorganic ultraviolet absorbing agent to be contained in a water-repellent film 38 and Comparative Examples 1 to 2 in which nozzles are formed by allowing an organic ultraviolet absorbing agent to be contained in a water-repellent film 38 for the purpose of comparison with these Examples.

### Example 1

First, titanium oxide (having a melting point of 1640° C.) is blended as an inorganic ultraviolet absorbing agent into polytetrafluoroethylene (PTFE) at a ratio of 10 wt % to prepare a water-repellent film coating liquid, which is then applied onto a polyimide film (nozzle plate) surface to form a water-repellent film having a thickness of 2 μm.

After performing a thermal treatment of 320° C. on this polyimide film on which the water repellent film has been formed, an excimer laser (condition: wavelength of 248 nm) is applied to the polyimide film from the water-repellent film forming surface side so as to form a narrow hole (nozzle) having a diameter of 25 μm.

### Example 2

A narrow hole (nozzle) is formed in a polyimide film (nozzle plate) in the same manner as in Example 1 except that cerium oxide (having a melting point of 1950° C.) is used as an inorganic ultraviolet absorbing agent.

### Example 3

A narrow hole (nozzle) is formed in a polyimide film (nozzle plate) in the same manner as in Example 1 except that zinc oxide (having a melting point of 1975° C.) is used as an inorganic ultraviolet absorbing agent.

### Example 4

A narrow hole (nozzle) is formed in a polyimide film (nozzle plate) in the same manner as in Example 1 except that tin oxide (having a melting point of 1080° C.) is used as an inorganic ultraviolet absorbing agent.

### Example 5

A narrow hole (nozzle) is formed in a polyimide film (nozzle plate) in the same manner as in Example 1 except that iron oxide (having a melting point of 1360° C.) is used as an inorganic ultraviolet absorbing agent.

### Comparative Example 1

A narrow hole (nozzle) is formed in a polyimide film (nozzle plate) in the same manner as in Example 1 except that 2-(2-hydroxy-3′,5′-di-t-butylphenyl)-5-chlorobenzotriazole (having a melting point of about 155° C.) is used as an organic ultraviolet absorbing agent instead of an inorganic ultraviolet absorbing agent.

### Comparative Example 2

A narrow hole (nozzle) is formed in a polyimide film (nozzle plate) in the same manner as in Example 1 except that 2-(2′-hydroxy-5′-t-octylphenyl)benzotriazole (having a melting point of about 105° C.) is used as an organic ultraviolet absorbing agent instead of an inorganic ultraviolet absorbing agent.

—Evaluation—

Evaluation is made in the following manner. The nozzle shape is observed after nozzles have been formed, so as to examine the presence or absence of burrs at the nozzle end and poorness of the nozzle shape. As an evaluation, good ones with no burrs and no shape poorness are evaluated as A; those with some burrs or shape poorness are evaluated as B; and those having burrs or shape poorness in almost all the nozzles are evaluated as C.

—Evaluation Result—

When the above evaluation is made, an evaluation result is obtained such that Examples 1 to 5 are evaluated as A; Comparative Example 1 is evaluated as B; and Comparative Example 2 is evaluated as C.

From this evaluation result, it will be understood that, in this embodiment, by allowing an inorganic ultraviolet absorbing agent to be contained in a water-repellent film, the inorganic ultraviolet absorbing agent can maintain its ultraviolet absorption capability without being decomposed even if a thermal treatment using a high temperature is applied after forming the water-repellent film, and even with an SUS plate (nozzle plate) on which a thick water-repellent film is formed, good nozzles can be formed with the excimer laser.

Thus, according to the invention, it is possible to provide a droplet ejection head having a water-repellent film formed on a nozzle surface as well as a method of producing the same, wherein good nozzles can always be formed irrespective of the production steps. Further, the invention can also be applied to a droplet ejection apparatus provided with this droplet ejection head.

What is claimed is:

1. A droplet ejection head comprising a nozzle plate provided with a nozzle for ejecting droplets and a water-repellent film provided on the nozzle plate, wherein the water-repellent film contains an inorganic ultraviolet absorbing agent.

2. The droplet ejection head of claim 1I wherein the inorganic ultraviolet absorbing agent is selected from the group consisting of titanium oxide, cerium oxide, zinc oxide, tin oxide, and iron oxide.

3. The droplet ejection head of claim 1, wherein the water-repellent film is formed by spray coating.

4. The droplet ejection head of claim 1, wherein the nozzle plate consists of polyimide.

5. The droplet ejection head of claim 1, wherein the water-repellent film contains polytetrafluoroethylene resin (PTFE), tetrafluoroethylene-perfluoroalkoxyethylene copolymer resin (PFA) or tetrafluoroethylene-hexafluoropropylene copolymer resin (FEP).

6. A method of producing a droplet ejection head comprising:
forming a water-repellent film containing an inorganic ultraviolet absorbing agent on a nozzle plate before forming a nozzle for ejecting droplets; and
forming the nozzle in the nozzle plate by applying to the nozzle plate a laser beam having a wavelength in the ultraviolet region from a side of a surface where the water-repellent film is formed.

7. The method of producing a droplet ejection head of claim 6, further comprising joining a flow passageway plate, which is provided with at least a part of a flow passageway for droplets that is in communication with the nozzle, onto a surface that is opposite to the surface of the nozzle plate where the water-repellent film is formed, after forming the water-repellent film.

8. The method of producing a droplet ejection head of claim 6, wherein the inorganic ultraviolet absorbing agent is selected from the group consisting of titanium oxide, cerium oxide, zinc oxide, tin oxide, and iron oxide.

9. The method of producing a droplet ejection head of claim 6, wherein the water-repellent film is formed by spray coating.

10. The method of producing a droplet ejection head of claim 6, wherein the nozzle plate consists of polyimide.

11. The method of producing a droplet ejection head of claim 6, wherein the water-repellent film contains polytetrafluoroethylene resin (PTFE), tetrafluoroethylene-perfluoroalkoxyethylene copolymer resin (PFA) or tetrafluoroethylene-hexafluoropropylene copolymer resin (FEP).

12. A droplet ejection apparatus provided with the droplet ejection head of claim 1.

13. A droplet ejection apparatus provided with the droplet ejection head of claim 2.

14. A droplet ejection apparatus provided with the droplet ejection head of claim 3.

15. A droplet ejection apparatus provided with the droplet ejection head of claim 4.

16. A droplet ejection apparatus provided with the droplet ejection head of claim 5.
